(19) United States
(12) Patent Application Publication
(10) Pub. No.: US 2009/0165731 A1
(43) Pub. Date: Jul. 2, 2009

(54) Scratching and self-grooming tool

(75) Inventors: Cynthia Garry, Dillsburg, PA (US); Rodney Hoffman, Ramona, OK (US)

Correspondence Address: LAW OFFICES OF STUART J. FRIEDMAN, 28930 RIDGE ROAD, MT. AIRY, MD, 21771, US

(73) Assignee: Cynthia Garry, Dillsburg, PA (US)

(21) Appl. No.: 12/009,746

(22) Filed: Jan. 22, 2008

Related U.S. Application Data
(63) Continuation-in-part of application No. 29/294,192, filed on Dec. 27, 2007, now Pat. No. D584863.

(51) Int. Cl. A01K 13/00

(52) U.S. Cl. 119/621

(57) ABSTRACT

A self-grooming tool for mammals consists of a quadrilateral pad which has a front face having a plurality of teeth extending therefrom, a rear face and opposed peripheral end and side walls, the opposed peripheral walls having complementary configurations. A recess in the rear face defines two planar areas, the pad being foldable about the recess between a flat position and a folded position. One each of the peripheral end and side walls have laterally projecting flanges, the underside of each flange being co-planar with the rear face of the pad and the flanges having a thickness which is less than about one-half the thickness of the pad. The other of each of the peripheral end and side walls have lengthwise extending undercuts formed therein, having the same shape and dimensions as the flanges, and communicating with the rear face of the pad.

### CROSS REFERENCE TO RELATED APPLICATIONS

This application is a continuation-in-part of pending U.S. application Ser. No. 29/294,192, filed Dec. 27, 2007.

### FIELD OF THE INVENTION

The present invention relates to scratching and self-grooming devices for animals and, more particularly, to a scratching and self-grooming pad which may be interlocked with other such pads to form a grid or linear pattern to facilitate the self-grooming of animals.

### BACKGROUND OF THE INVENTION

Self-grooming tools intended primarily for small animals, such as cats and dogs, are well known and comprise, generally, a toothed plate, which may be made out of any plastic, rubber or combination thereof, and which may be bent to conform to non-planar surfaces or to corners. In U.S. Pat. No. 4,747,371-Leopold and U.S. Pat. No. 4,807,569-Leopold, each plate includes a flat surface having a plurality of spaced teeth extending outwardly therefrom. The teeth are spaced both vertically and horizontally on the plate in a predetermined pattern. The teeth are substantially uniform in shape and size and are conical in shape, with the base of the tooth being the thickest in diameter, tapering along the stem of the tooth to a blunt cone tip. The plate may be secured to a wall, door or other surface by adhesive, screws, fasteners, or other means. In U.S. Pat. No. 4,907,540-Reynolds a cat self-grooming tool is disclosed which includes two planar surfaces attached in the middle by a thin plastic strip serving as a hinge and allowing the angle between the planar surfaces to range between 0° and slightly over 180°. Each of the planar surfaces is covered with a plurality of brush bristles arranged in a pattern of columns and rows. In one embodiment, alternating rows of the bristles are offset from each other so that every other row has an essentially identical pattern of bristles. The brush bristle structure may be mounted on a wall using a mounting bracket to which the planar surfaces are attached.

In many cases, particularly for larger animals such as large dogs, horses, and other large animals, a single toothed or bristled plate is inadequate and the separate mounting on a wall of multiple individual plates is impractical. Accordingly, there is a need for a self-grooming tool which is suitable for large animals as well as for small animals.

### SUMMARY OF THE INVENTION

It is, therefore, a primary object of the present invention to provide a self-grooming tool which comprises a planar pad having a plurality of spaced teeth extending outwardly from the front face thereof and which may be interlocked with multiple other such planar pads to form a grid or linear pattern to facilitate the self-grooming of both large and small animals.

It is another object of the present invention to provide a self grooming tool which is sufficiently robust and durable to effectively function as a self-grooming tool for large animals.

It is still another object of the present invention to provide a self-grooming tool which includes a generally V-shaped channel recess extending longitudinally in the rear face of the pad to allow the pad to bend around the recess between its normally planar orientation and an orientation wherein the planar portions on opposite sides of the recess form an angle up to at least 90° therebetween.

It is yet another object of the present invention to provide a self-grooming tool which is generally quadrilateral and includes flanges protruding from one of the end walls and one of the side walls in the plane of the rear face of the pad and further includes undercuts formed in the other of the end walls and side walls in the rear face of the pad, whereby multiple similar pads can be interlocked side to side and/or end to end to form a grid or linear pattern.

The foregoing and other objects are achieved in accordance with the present invention by providing a self-grooming tool for animals and humans comprising:

a planar, generally quadrilateral shaped pad having a front face and a rear face and opposed peripheral end and side walls spacing said front face from said rear face, said opposed peripheral end walls having complementary configurations and said opposed peripheral side walls having complementary configurations;

said rear face having a recess longitudinally extending between said peripheral end walls for separating said rear face into two planar areas, said pad being foldable about said recess between a flat position wherein said two planar areas form an angle therebetween of about 180° and a folded position wherein said two planar areas form an angle therebetween which can vary between less than 180° and about 90°;

said front face having a plurality of flexible, resilient teeth extending therefrom; and

means for interlocking said pad with adjacent similar planar pads having like means for interlocking, said means for interlocking comprising
laterally projecting flanges on one of the peripheral end walls and one of the peripheral side walls, said flanges being generally planar and having an underside and an upperside, the underside of each said flange being co-planar with the rear face of said pad and said flanges having a thickness which is equal to or less than half the thickness of said pad measured at other than said recess, said uppersides of said flanges being spaced from and parallel to said front face of said pad, and
lengthwise extending undercuts formed in the other of the peripheral end walls and the other of the peripheral side walls, each lengthwise extending undercut having the same shape and dimensions as the flanges on the opposed peripheral end wall and the opposed peripheral side wall, respectively, said undercuts communicating with the rear face of said pad; whereby the flanges on one pad can interlock with the undercuts on similar adjacent pads and the peripheral end walls and side walls of one pad can engage the complementary end walls and sidewalls, respectively, on similar adjacent pads to form grids and linear patterns of pads in which the pads are restrained from relative movement with respect to each other.

In another aspect of the present invention, the flange extends the entire length of the peripheral side wall from which it projects and the undercut extends the entire length of the peripheral side wall in which it is formed. Likewise, the flange on the peripheral end wall extends the entire length of the peripheral end wall from which it projects, except where the flange traverses the recess, and the undercut formed in the peripheral end wall extends the entire length of the peripheral end wall in which it is formed, except where the flange traverses the recess.

In still another aspect of the present invention, the peripheral side and/or end walls are linear or include an arcuate portion or include a complex curve portion or include undulations defining alternate bulges and recesses.

In yet another aspect of the present invention, there are no teeth on the portion of the front face overlying at least a part of the recess and the thickness of the pad at the recess is less than the thickness of the pad at locations on either side of the recess. These features facilitate the folding of the pad to allow it to be mounted on outside angles of structures and on non-planar walls.

### BRIEF DESCRIPTION OF THE DRAWINGS

FIG. 1 is a perspective view of the scratching and self-grooming tool of the present invention.

FIG. 2 is a front elevational view of the tool of FIG. 1.

FIG. 3 is a top plan view of the tool of FIG. 1.

FIG. 4 is a bottom plan view of the tool of FIG. 1.

FIG. 5 is a left side elevational view of the tool of FIG. 1.

FIG. 6 is right side elevational view of the tool of FIG. 1.

FIG. 7 is a rear elevational view of the tool of FIG. 1.

FIG. 8 is a perspective view of multiple interlocked tools of FIG. 1 attached to a 90° corner.

FIG. 9 is a top plan view of multiple interlocked tools of FIG. 1 attached to a flat surface.

### DESCRIPTION OF THE PREFERRED EMBODIMENT

The present invention provides a scratching and self-grooming tool for small or large animal use. The self-grooming tool is useful for the self-grooming of small animals in the home, such as cats and dogs. Equally importantly, it is useful either as a single tool or as multiple tools interlocked to form a grid or linear pattern for larger animals in the barn or barn yard, such as horses. The self-grooming tool may also be used by other mammals, such as humans, e.g., for back scratching.

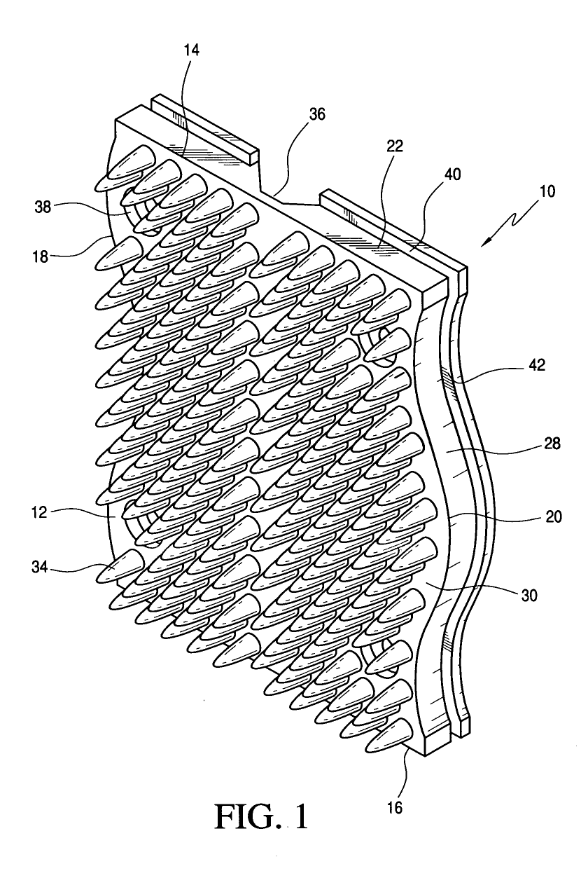

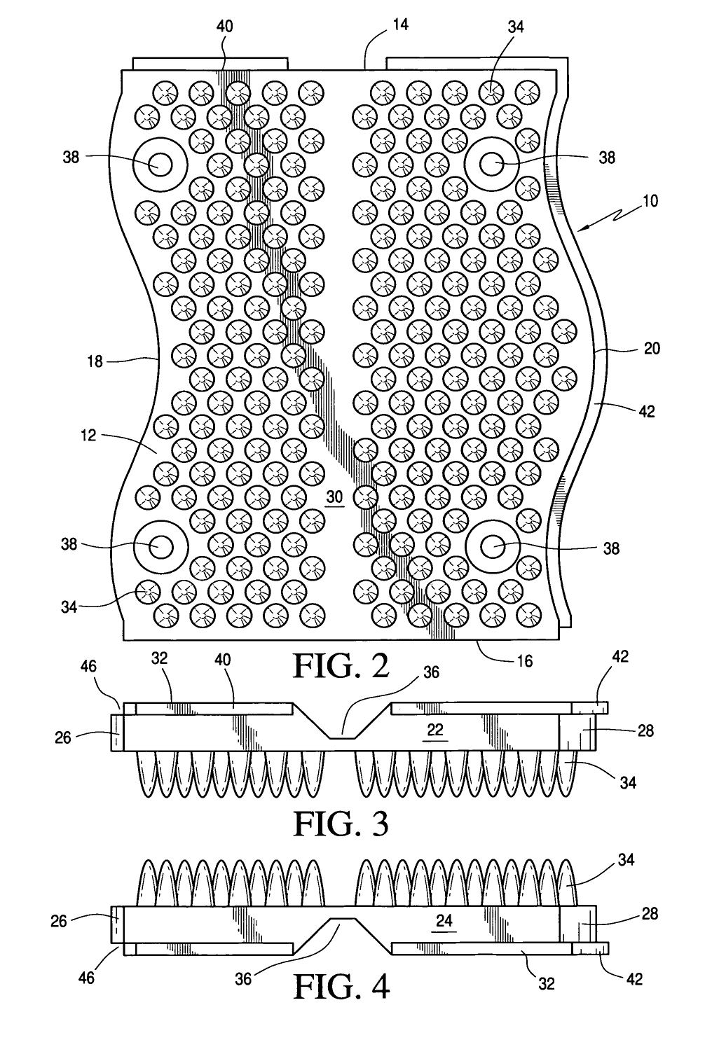

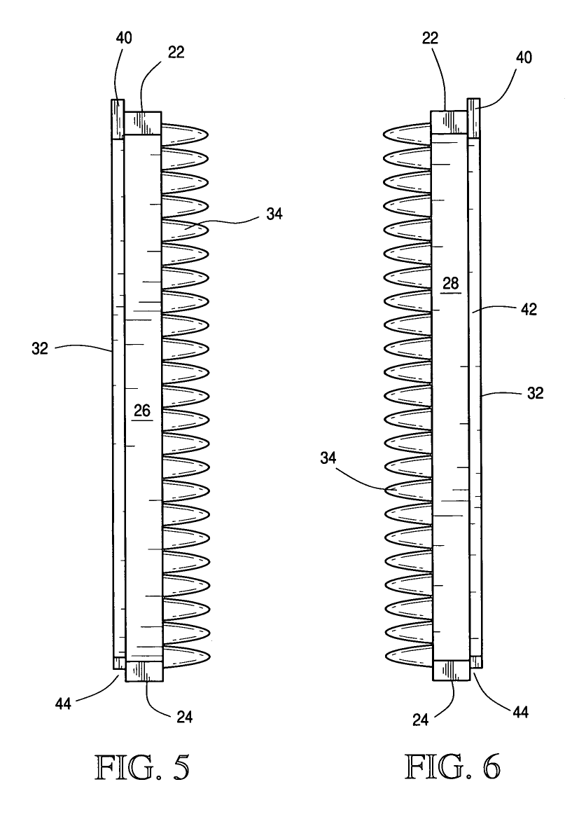

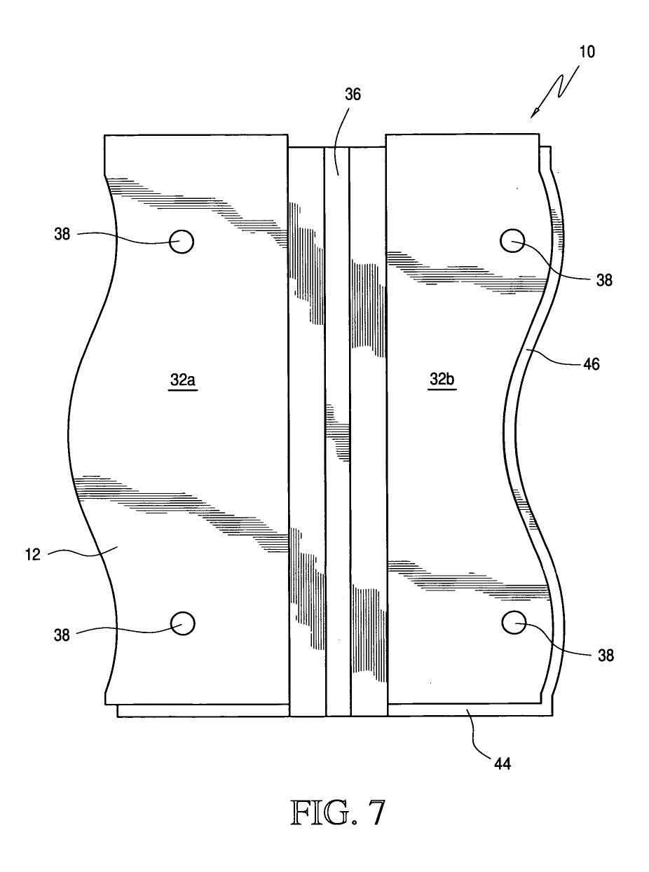

Referring first to FIGS. 1-7, there is shown the scratching and self-grooming tool 10 of the present invention. The tool comprises a generally planar, generally quadrilateral shaped, preferably rectangular, pad 12, having upper and lower ends 14, 16 and left and right sides 18, 20. The ends and sides of pad 12 may be linear, as shown for ends 14, 16, or curved or arcuate, as shown for sides 18, 20. Peripheral end walls 22, 24 and peripheral side walls 26, 28, having the same linear or curved configuarations as their respective ends 14, 16 and sides 18, 20, space the front face 30 of pad 12 from the rear face 32. For purposes of using multiple identical interlocked tools to form a grid or linear pattern, as will be described more fully hereinafter, particularly for larger animals, it is preferred that opposed peripheral end walls and opposed peripheral side walls of pad 12 have substantially complementary configurations. Thus, as can be seen from FIG. 2, where the upper peripheral end wall 22 is linear, then the opposed lower peripheral end wall 24 is also linear. Likewise, where the left peripheral side wall 26 is arcuate in a particular shape, then the opposed right peripheral side wall 28 is substantially complementary in the same shape. Continuing with reference to FIGS. 1-7, viewing left peripheral side wall 26 from upper peripheral end wall 22 to lower peripheral end wall 24, and starting at the intersection of upper peripheral end wall 22 and left peripheral side wall 26, the left peripheral side wall 26 curves initially toward the left, then curves toward the right and curves again toward the left before, finally, curving again toward the right to the intersection of left peripheral side wall 26 with lower peripheral end wall 24. Now, viewing right peripheral side wall 28 in the same manner, and starting at the intersection of upper peripheral end wall 22 and right peripheral side wall 28, it can be seen that right peripheral side wall 28 also initially curves toward the left, then curves toward the right and curves again toward the left before, finally, curving again toward the right to the intersection of right peripheral side wall 28 with lower peripheral end wall 24. It will be appreciated that the bulges and recesses comprising left peripheral side wall 26 are complementary to the bulges and recesses comprising right peripheral side wall 28, in both shape and dimensions, such that if the right peripheral side wall 28 of one pad 12 is placed adjacent the left peripheral side wall 26 of a similar pad 12, the bulges and recesses of the respective pads would interengage. As will be seen hereinafter, the complex curvature of left and right peripheral side walls 26, 28, i.e., the undulations defining alternate bulges and recesses with reference to each peripheral side wall 26, 28, is very useful in forming a grid or linear pattern with multiple interlocking similar pads 12 in which the pads 12 are restrained against relative movement in any direction within the pattern. The restraint is created by the interengaging of the opposed peripheral end walls 22, 24 and the opposed peripheral side walls 26, 28.

Front face 30 includes a plurality of horizontally and vertically arranged, spaced, flexible teeth 34 protruding forwardly therefrom, as can best be seen in FIGS. 1 and 3-6. The rear face 32 of pad 12 is generally planar but includes a longitudinal, generally V-shaped channel recess 36 extending between upper peripheral end wall 22 and lower peripheral end wall 24 and generally located midway between peripheral side walls 26, 28. The thickness of the pad 12 at recess 36 is less than half the thickness of pad 12 and, preferably, about one quarter the thickness of pad 12 at other locations. The recess 36 desirably divides the rear face 32 of pad 12 into generally equal sized planar portions 32a, 32b and the relatively small thickness of pad 12 at recess 36 allows pad 12 to fold around recess 36 between a flat or 180° position and a folded position where the angle between planar portions 30a, 30b may vary between less than 180° and about 90°. To facilitate folding pad 12, teeth 34 are omitted on the front face 30 at longitudinal locations overlying the length of recess 36.

Teeth 34 are arranged in a pattern of rows and columns which, preferably, substantially cover front face 30 of pad 12 except for a longitudinal portion of front face 30 overlying recess 36. Adjacent rows of teeth 34 may be aligned with each other or, as in the embodiment shown in FIGS. 1 and 2, alternating rows of the teeth may be offset from each other so that every other row has an essentially identical pattern of teeth. Alternatively, the teeth may be arranged in any other desired pattern, whether it substantially covers front face 30 or not, except there are no teeth on the front face 30 where pad 12 has a reduced thickness overlying recess 36. The teeth are preferably substantially uniform in size and shape and are conical in shape, with the base of each tooth being the largest in diameter, tapering along the stem of the tooth to a cone tip, which is preferably not sharply pointed.

Pad 12 and teeth 34 are preferably formed unitary and are preferably formed of the same material. The material must be thick and tough enough for the pad 12 to be durable and sufficiently rugged for use with large animals, such as horses, flexible enough that pad 12 may be easily bent along reduced thickness recess 36 to conform to any non-planar surface to which it is to be attached, and resilient enough that teeth 34 yield when an animal scratches its body part across pad 12 yet substantially immediately return to their original position after the body part passes. To accomplish this it is preferred that the tool 10 be made of an elastomeric rubber, such as silicone rubber, although it will be appreciated that various flexible plastics and other rubbers will also work.

Pad 12 may be mounted in a flat configuration, for example, against a wall, floor or wide beam or board. Alternatively, pad 12 may be mounted on the corner of a fence post, on an outward facing horizontal or vertical corner of any structure or on a wall which is other than planar. In one preferred embodiment, four countersunk apertures 38 are formed in pad 12 near each corner for receiving standard screws and washers for securing pad 12 to a surface. In such an embodiment, it will be appreciated that no teeth 34 are present where the apertures 38 are formed. In other embodiments, the apertures 38 may be omitted and the pad 12 secured using an adhesive, suction cups, or other styles of fasteners.

While a single pad 12 may advantageously be used for self-grooming of small animals, such as cats and small dogs, the present invention is capable of using multiple, i.e., at least two, similar pads 12 arranged in grids and linear patterns for larger animals. In order that these multiple, similar pads 12 may be interlocked end to end and side to side and restrained from relative movement with respect to each other, one of the peripheral end walls 22, 24 and one of the peripheral side walls 26, 28 include a laterally projecting flange 40, 42, desirably formed unitary with pad 12, the underside of which is co-planar with the rear face 32 of pad 12. Flanges 40, 42 have a thickness dimension between their underside and their upperside which is equal to or less than half the thickness of pad 12 between its front face 30 and its rear face 32, measured at other than said recess 36, such that the uppersides of flanges 40, 42 are spaced from and parallel to the front face 30 of pad 12. Desirably, the thickness of flanges 40, 42 is considerably less than half the thickness of pad 12 and, most desirably, is about one quarter the thickness of pad 12. Preferably, flanges 40, 42 project laterally from the peripheral end and side walls a distance which is equal to or less than half the thickness of pad 12, measured at other than said recess 36 and, most preferably, a distance which is equal to about one quarter the thickness of pad 12. Desirably, flanges 40, 42 extend the entire length of the side wall from which it projects and the entire length of the end wall from which it projects, except where it traverses the V-shaped channel recess 36.

The peripheral end wall 22, 24 and the peripheral side wall 26, 28 which does not have a laterally projecting flange 40, 42 each include a lengthwise extending undercut or recess 44, 46, having the same shape and dimensions as flanges 40, 42, communicating with rear face 32 of pad 12. Desirably, undercuts 44, 46 extend the entire length of the side wall in which it is formed and the entire length of the end wall in which it is formed, except where it traverses the V-shaped channel recess 36. Where the flanges 40, 42 and undercuts 44, 46 do not extend along the entire length of the respective end and side walls, the flange 40 and undercut 44 associated with the end walls 22, 24 should be the same length and be correspondingly positioned along the end walls such that, when forming a pattern of pads 12, flange 40 on one pad 12 will interlock with the undercut 44 on an adjacent pad 12. Likewise, the flange 42 and undercut 46 associated with the side walls 26, 28 should be the same length and be correspondingly positioned along the side walls such that, when forming a pattern of pads 12, flange 42 on one pad 12 will interlock with the undercut 46 on an adjacent pad 12.

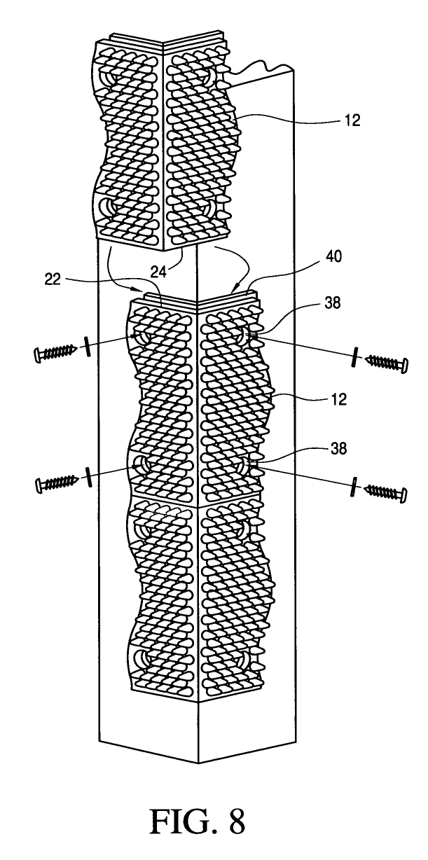

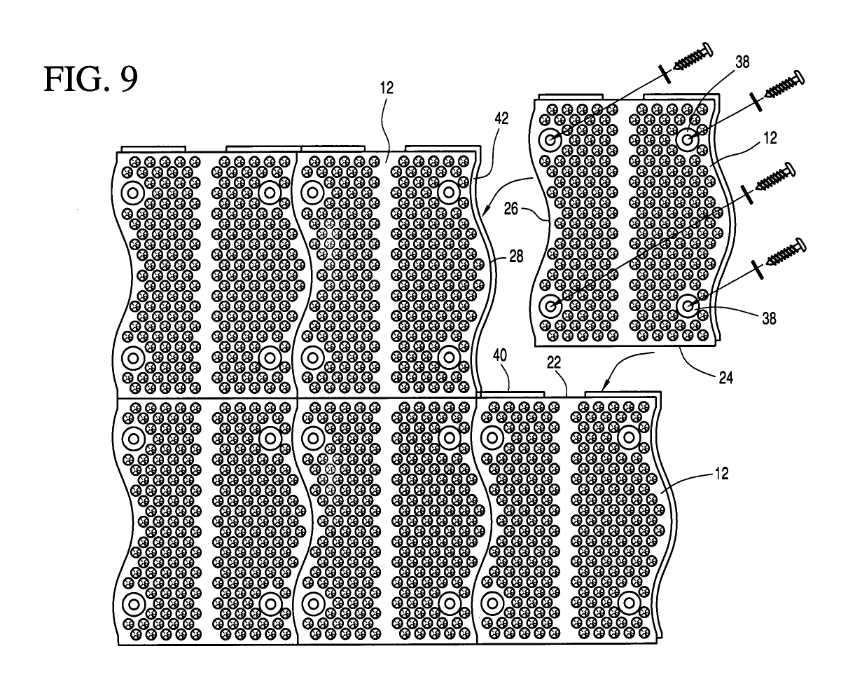

Referring to FIGS. 8 and 9, there is illustrated the manner in which pads 12 may be used to form a grid or linear pattern when attached to an outside vertical corner (FIG. 8) and when attached to a flat wall (FIG. 9). With reference to FIG. 8, it can be seen that flange 40 on peripheral end wall 22 of middle pad 12 interlocks end to end with undercut 44 on peripheral end wall 24 of the adjacent upper pad 12. It can also be seen how pads 12 are attached to an outside corner using conventional screws and washers extending through apertures 38. With reference to FIG. 9, it can be seen that flange 40 on peripheral end wall 22 of lower right pad 12 interlocks end to end with undercut 44 on peripheral end wall 24 of the adjacent upper right pad 12. At the same time, flange 42 on peripheral side wall 28 of the upper middle pad 12 interlocks side to side with undercut 46 on peripheral side wall 26 of the adjacent upper right pad 12. It can also be seen how pads 12 are attached to a flat wall using conventional screws and washers extending through apertures 38.

For purposes of illustration only, as viewed in FIG. 2, pad 12 may usefully have an overall width dimension of about 5.1328 inches and an overall height dimension of about 6.125 inches. Flanges 40, 42 have a thickness of 0.125 inches and extend laterally from the end and side walls a distance of 0.125 inches. Correspondingly, undercuts 44, 46 have the same dimensions. The overall thickness of pad 12 between front and rear faces 30, 32 is 0.5 inches, although at recess 36 the pad thickness reduces to about 0.125 inches, and teeth 34 have a uniform height of 0.5 inches. It will be appreciated that these dimensions have been found to be practical and useful for both large and small animals, particularly in view of the capability of pads 12 to interlock with adjacent pads 12 to form grids and linear patterns. However, the self-grooming tool of the present invention may be made in different sizes depending upon the size of the animal for whose use the self-grooming device is intended.

While the present invention has been described in terms of specific embodiments thereof, it will be understood that no limitations are intended to the details of construction or design other than as defined in the appended claims.

1. A self-grooming tool for animals and humans comprising:
a planar, generally quadrilateral shaped pad having a front face and a rear face and opposed peripheral end and side walls spacing said front face from said rear face, said opposed peripheral end walls having complementary configurations and said opposed peripheral side walls having complementary configurations;
said rear face having a recess longitudinally extending between said peripheral end walls for separating said rear face into two planar areas, said pad being foldable about said recess between a flat position wherein said two planar areas form an angle therebetween of about 180° and a folded position wherein said two planar areas form an angle therebetween which can vary between less than 180° and about 90°;
said front face having a plurality of flexible, resilient teeth extending therefrom; and
means for interlocking said pad with adjacent similar planar pads having like means for interlocking, said means for interlocking comprising
laterally projecting flanges on one of the peripheral end walls and one of the peripheral side walls, said flanges being generally planar and having an underside and an upperside, the underside of each said flange being co-planar with the rear face of said pad and said flanges having a thickness which is equal to or less than half the thickness of said pad measured at other than said recess, said uppersides of said flanges being spaced from and parallel to said front face of said pad, and
lengthwise extending undercuts formed in the other of the peripheral end walls and the other of the peripheral side walls, each lengthwise extending undercut having the same shape and dimensions as the flanges on the opposed peripheral end wall and the opposed peripheral side wall, respectively, said undercuts communicating with the rear face of said pad;
whereby the flanges on one pad can interlock with the undercuts on similar adjacent pads and the peripheral end walls and side walls of one pad can engage the complementary end walls and sidewalls, respectively, on similar adjacent pads to form grids and linear patterns of pads in which the pads are restrained from relative movement with respect to each other.

2. A self-grooming tool, as claimed in claim 1, wherein the thickness of said pad at said recess is less than the thickness of the pad at locations on either side of said recess.

3. A self-grooming tool, as claimed in claim 2, wherein the thickness of said pad at said recess is about one quarter of the thickness of the pad at locations on either side of said recess.

4. A self-grooming tool, as claimed in claim 1, wherein said flange extends the entire length of the peripheral side wall from which it projects.

5. A self-grooming tool, as claimed in claim 4, wherein said undercut extends the entire length of the peripheral side wall in which it is formed.

6. A self-grooming tool, as claimed in claim 1, wherein said flange extends the entire length of the peripheral end wall from which it projects, except where said flange traverses said recess.

7. A self-grooming tool, as claimed in claim 6, wherein said undercut extends the entire length of the peripheral end wall in which it is formed, except where said undercut traverses said recess.

8. A self-grooming tool, as claimed in claim 1, wherein the thickness of said flanges is equal to about one quarter of the thickness of said pad.

9. A self-grooming-tool, as claimed in claim 1, wherein said flanges project laterally from the peripheral end and peripheral side walls a distance which is equal to or less than half the thickness of said pad measured at other than said recess.

10. A self-grooming tool, as claimed in claim 9, wherein said flanges project a distance which is equal to about one quarter of the thickness of said pad.

11. A self-grooming tool, as claimed in claim 1, wherein the peripheral side and/or peripheral end walls are linear.

12. A self-grooming tool, as claimed in claim 1, wherein the peripheral side and/or peripheral end walls include an arcuate portion.

13. A self-grooming tool, as claimed in claim 12, wherein the peripheral side and/or peripheral end walls include a complex curve portion.

14. A self-grooming tool, as claimed in claim 12, wherein the peripheral side and/or peripheral end walls include undulations defining alternate bulges and recesses.

15. A self-grooming tool, as claimed in claim 1, wherein said teeth and flanges are formed unitary with said pad.

16. A self-grooming tool, as claimed in claim 1, wherein said plurality of teeth are arranged in a pattern of rows and columns.

17. A self-grooming tool, as claimed in claim 1, wherein there are no teeth on the portion of the front face overlying at least a portion of said recess.

18. A self-grooming tool, as claimed in claim 2, wherein there are no teeth on the portion of the front face where said pad has a reduced thickness at said recess.

19. A self-grooming tool, as claimed in claim 1, wherein said pad is formed of a silicone rubber.

20. A self-grooming tool, as claimed in claim 1, further including means for securing said pad to a support.
